(19) United States
(12) Patent Application Publication
(10) Pub. No.: US 2008/0258113 A1
(43) Pub. Date: Oct. 23, 2008

(54) Phosphonium Ionic Liquids as Recyclable Solvents for Solution Phase Chemistry

(75) Inventors: Jason Clyburne, Vancouver (CA); Taramatee Ramnial, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: SIMON FRASER UNIVERSITY, Burnaby, BC (CA)

(21) Appl. No.: 11/572,135

(22) PCT Filed: Jul. 15, 2005
(86) PCT No.: PCT/CA2005/001119

§ 371 Date: Nov. 23, 2007

Related U.S. Application Data
(60) Provisional application No. 60/588,318, filed on Jul. 16, 2004.

(51) Int. Cl. B01F 1/00; B01F 17/20; C07F 9/54

(52) U.S. Cl. 252/364

(57) ABSTRACT

This application relates to the use of phosphonium-based ionic liquids as recyclable solvents for solution phase chemistry. The ionic liquids may be used, for example, as solvents for reactions involving Grignard reagents, hydridic reagents, metallic and non-metallic reducing agents, and strong bases, including nucleophilic carbenes and Wittig reagents. In one embodiment the invention may comprise homogeneous mixtures of strong bases/nucleophiles/reducing agents and tetrahydrocarbylphosphonium salt ionic liquids. The invention also relates to chemical processes that may proceed in either minimally flammable solvent, or a complete absence of flammable solvent, including systems containing strong reducing agents such as alkali and alkaline metals or metal and non-metal hydrides. Methods for generating anions and nucleophililic carbenes (imidazol-2-ylidenes) (and complexes derived from them) in phosphonium-based ionic liquids are also described. The invention demonstrates the feasibility of using phosphonium-based ionic liquids as a reliable reaction media for a wide variety of basic reagents. The problems associated with C—H activation in imidazolium-based ionic liquids by highly reactive bases are not observed for phosphonium-based ionic liquids.

### REFERENCE TO RELATED APPLICATIONS

This application claims the benefit of U.S. provisional patent application Ser. No. 60/588,318 filed 16 Jul. 2004, which is hereby incorporated by reference.

### FIELD OF THE INVENTION

This application relates to the use of ionic liquid solvents for solution phase chemistry.

### BACKGROUND OF THE INVENTION

Environmental pressure to reduce waste and re-use materials has prompted studies into “Green” chemistry.^{1,2} Various reports have reviewed these emerging fields^{3,4,5} and it is apparent that one of the most difficult areas to make environmentally friendlier is solution phase chemistry. Solvents play key roles in chemical reactions; they serve to homogenize and mix reactants, and also act as a heat sink for exothermic processes. It is clear that one of the biggest industrial concerns is replacement of volatile organic compounds (VOCs),⁶ particularly those that are toxic, such as CH₂Cl₂, and those that are hazardous to handle. Of the latter class of VOCs, the most offensive are ethers, which are volatile, flammable, and form explosive peroxides. Unfortunately, ethereal solvents are commonly used for reactions involving strong bases⁶ and few alternatives are currently available.

Successful attempts to replace or limit the use of VOCs have been made in some cases, and these include processes that use no solvent⁷ or new solvent systems such as supercritical H₂O^{8,9,10} supercritical CO₂,¹¹ fluorous solvents,¹² and ionic liquids (ILs).^{2,13,14}

Perhaps the most extensively studied class of ILs is based upon the imidazolium ion, 1, and the most common example is the ethylmethylimidazolium ion with anions such as [BF₄] and [AlCl₄].¹⁵

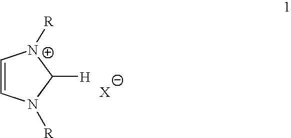

Notwithstanding the sensitivity of the anions, ILs of this class have garnered attention since they facilitate many important chemical reactions. Solutions of IL 1 support reactions such as alkene oligomerizations, alkylations,¹⁶ and acylations.¹⁷ However, imidazolium-based solvent systems are unsuitable for reactions involving either active metals (i.e., Na or K) or in reactions that involve strong bases (i.e. Grignards, organolithiums, and amides) since these reagents react with the imidazolium-based solvents. For instance, imidazolium ions react with potassium metal to produce imidazol-2-ylidenes (N-heterocyclic carbenes, NHCs),¹⁸ and treatment of imidazolium ions with bases, such as lithium di-iso-propylamide or potassium tert-butoxide, is the standard method for the generation of NHCs.¹⁹ Aggarwal et al. have shown that even with weaker bases, such as amines, low reported yields from the Baylis-Hillman reaction in an imidazolium-based ionic liquid were the result of addition of the deprotonated imidazolium cation to an aldehyde.²⁰ Finally, the other “Greener” solvent alternatives, namely H₂O^{8,21,22} and supercritical CO₂,¹¹ react with strong bases.

Dupont et al. have recognized that under certain reaction conditions, both the cation and the anion of imidazolium-based ionic liquids may undergo undesirable transformations.²³ Accordingly, some caution must be exercised when using imidazolium-based ionic liquids as solvents. For example, as explained above, when such ILs are employed under basic conditions, carbenes are likely to form with possibly detrimental results. Under reduction conditions in an electrochemical cell imidazolium-based ionic liquids also decompose.²⁴ Simple alkylation of the 2-position of the imidazolium ion does not prevent unfavorable deprotonation and redox chemistry, as was shown by the deprotonation of the substituted pentamethylimidazolium ion, which produces an ylidic olefin, 1,3,4,5-tetramethyl-2-methyleneimidazoline.²⁵ Other ions used in ionic liquids also undergo unfavorable chemistry with reducing agents. For example, pyridinium-based ionic liquids react with reducing agents or in an electrochemical cell to produce highly colored dimeric materials.^{26.27} Some of these materials are based upon the general structure of viologen, among the most carcinogenic compounds known.

The use of phosphonium-based (PILs) rather than imidazolium-based ionic liquids as solvents is also known in the prior art. Canadian patent application No. 2,356,709, which was laid open for public inspection on 3 Mar. 2003, describes the use of tetrahydrocarbylphosphonium salt ionic liquids as solvents for dissolving saturated hydrocarbons. The '709 application describes how reaction products can be separated from the ionic liquid by the addition of water, resulting in the formation of separate liquid phases.

United States patent application No. 2004/0106823 published 3 Jun. 2004 describes various phosphonium phosphinate compounds useful as ionic liquids. Such compounds may be used as polar solvents for use in chemical reactions, such as Michael additions, aryl coupling, Diels-Alder, alkylation, biphasic catalysis, Heck reactions, hydrogenation or some enzymatic reactions.

It is also well known that phosphonium ions are more thermally robust than ammonium ions.

Although phosphonium and ammonium ions have been used in nucleophilic reaction chemistry, specifically with the alkylation of 2-naphthoxide,^{29,30} the anion in that application is not very basic (pKa≈10).³¹ The use of phosphonium-based ionic liquids as solvents for Grignard reagents and other strong bases and nucleophiles has not been previously described in the prior art. As shown in FIG. 1, Grignard reagents are organomagnesium halides having the general formula RMgX that are commonly used in synthetic chemistry and are highly basic.^{32,33} For example, Grignard reagents can be used in the synthesis of alcohols and carboxylic acids. While non-aqueous ethereal solvents are commonly used in Grignard chemistry, the inventors have determined that Grignard reagents and other strong bases are also persistent and reactive in phosphonium-based ionic liquids. Further, some basic compounds, such as nucleophilic carbenes, can be generated in the phosphonium-based ionic liquids. Surprisingly, highly basic or nucleophilic reagents do not result in appreciable deprotonation of phosphonium-based ionic liquids to form phosphoranes. Thus the present invention demonstrates the feasibility of replacing volatile and flammable solvents typically used for Grignard chemistry and the like with more environmentally friendly and recyclable alternatives. The invention also demonstrates the usefulness of phosphonium-based ionic liquids as reliable solvents in which to produce strongly basic nucleophiles, such as nucleophilic carbenes, and also to dissolve and handle highly reactive molecules such as borane (BH₃).

### SUMMARY OF THE INVENTION

In accordance with the invention, a stable homogenous mixture is provided comprising a recyclable phosphonium-based ionic liquid solvent having the general formula I wherein R₁, R₂, R₃ and R₄ are each a hydrocarbyl or substituted hydrocarbyl moiety and X is an anion.

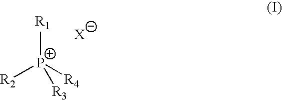

The mixture further comprises a reagent dissolved in the solvent, wherein the reagent is selected from the group consisting of a strong base, a reducing agent and a nucleophile.

In one embodiment R₁, R₂, R₃ and R₄ are each independently an alkyl group, a cycloalkyl group, an alkenyl group, an alkynyl group and an aryl group. The substituted hydrocarbyl moiety may possess a heteroatom (e.g. O, S, N, etc). The anion may be selected from the group consisting of halides, phosphinates, alkylphosphinates, alkylthiophosphinates, sulphonates, amides, tosylates, aluminates, borates, arsenates, cuprates, sulfates, nitrates, carboxylates, acetate, decanoate, citrate and tartrate.

In various particular embodiments of the invention the solvent is selected from the group consisting of trihexyl(tetradecyl) phosphonium chloride, trihexyl(tetradecyl) phosphonium decanoate, tripentyl(tetradecyl) phosphonium chloride, trioctyl(tetradecyl) phosphonium chloride, trihexyl(tetradecyl) phosphonium bromide, trihexyl(tetradecyl) phosphonium bis (trifluoromethylsulfonyl)imide, trihexyl(tetradecyl) phosphonium dicyclohexyl-phosphinate, trihexyl(tetradecyl) phosphonium tetrafluoroborate, trihexyl(tetradecyl) phosphonium triflate, trihexyl(tetradecyl) phosphonium tris(trifluoromethylsulfonyl)imide, trihexyl(tetradecyl) phosphonium tris(trifluoromethylsulfonyl)methide, and triisobutyl(tetradecyl)(methyl) phosphonium tosylate.

In one embodiment, the solvent is a purified solution substantially free of water. The solvent in the mixture may contain a relatively low concentration of ethereal solvent or may be substantially free of ethereal solvent. The mixture may also comprise a co-solvent selected from the group consisting of tetrahydrofuran, benzene, toluene and related solvents.

The reagent may be a Grignard reagent in one embodiment of the invention. In another embodiment, the reagent is a hydridic reagent. The hydridic reagent is selected from the group consisting of BH₃ or NaBH₄ or a substituted borane. The reagent may also comprise a carbene, a metal such as K or a metal amalgam.

The invention also relates to the use of the mixture described above to perform chemical reactions. The use may comprise, for example, adding a reactant to the mixture, such as an organic or organometallic compound. In one embodiment the reactant is a metal and the mixture further comprises of an imidazolium-based material.

The invention also relates to a method of using a phosphonium-based ionic liquid (PILs) for solution phase chemistry comprising providing a phosphonium-based ionic liquid solvent having the general structure (I) as described above; dissolving a reagent in the solvent to form a reagent solution, wherein the reagent is selected from the group consisting of a strong base, a reducing agent and a nucleophile; and using the reagent solution to perform a chemical reaction.

The method may comprise purifying the solvent prior to dissolving the reagent therein. The method may also include the step of recycling the solvent for reuse after the chemical reaction. The chemical reaction may comprise reacting the reagent with a reactant introduced into said solvent. The chemical reaction may, for example, be a reduction, an addition or a basic catalytic reaction. In some embodiments the reagent may be a Grignard reagent, a hydridic reagent, a metal, a metal amalgam or a nucleophilic carbene. The reactant may include an organic or an organometallic compound.

The chemical reaction may produce one or more organic or organometallic products, and the method may further include the steps of isolating the products from the solvent. The products may be isolated in a liquid phase layer separate from the solvent. The invention also encompasses products derived from the applicant's method.

### BRIEF DESCRIPTION OF THE DRAWINGS

In drawings, which describe embodiments of the invention but which, should not be considered as restricting the spirit or scope of the invention in any way.

FIG. 1 is a scheme showing reaction of a Grignard reagent, C₆H₅MgBr in trihexyl(tetradecyl) phosphonium chloride under different reaction conditions, namely (i) DMF, (ii) NaBH₄, (iii) acetone, (iv) benzaldehyde, (v) 2,6-dibromo-iodobenzene, (vi) Br₂ and (vii) CuCl₂. All reactions were followed by an aqueous work-up and an extraction with hexanes.

FIG. 2 is a photograph showing the separation of a solution mixture into a three-phase system with the organic layer on the top, the phosphonium-based ionic liquid in the middle and the aqueous layer on the bottom.

FIG. 3 is a space filling MM2 molecular model diagram of the structure of 1,3-bis(2,4,6-trimethylphenyl) imidazolium cation.

FIG. 4 is a space filling MM2 molecular model of the structure of trihexyl(tetradecyl) phosphonium cation showing the acidic C—H site surrounded by non-rigid alkyl groups.

FIG. 5 shows chemical structures of 1,3-bis(diethyl) imidazolium (left) and tetraethylphosphonium (right) ions examined in computational studies.

FIG. 6 shows estimated Mullikan partial charges on the 1,3-bis (diethyl) imidazolium and tetraethylphosphonium ions of FIG. 5.

### DETAILED DESCRIPTION OF THE INVENTION

Throughout the following description specific details are set forth in order to provide a more thorough understanding of the invention. However, the invention may be practiced without these particulars. In other instances, well known elements have not been shown or described in detail to avoid unnecessarily obscuring the present invention. Accordingly, the specification and drawings are to be regarded in an illustrative, rather than a restrictive, sense.

### Defined Terms

The current invention relates to the use of phosphonium-based ionic liquids (PILs) as recyclable solvents for solution phase chemistry. As used herein, the terms “phosphonium-based ionic liquids” and “PILs” means liquids having the following general formula (I) where R₁, R₂, R₃ and R₄ are each a hydrocarbyl or substituted hydrocarbyl moiety and X is any anion.

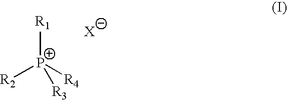

As used herein the term “hydrocarbyl” means a hydrocarbon radical having only carbon and hydrogen atoms and the term “substituted hydrocarbyl” means a hydrocarbyl radical wherein one or more, but not all, of the hydrogen and/or the carbon atoms are substituted, for example replaced by a halogen, nitrogen, oxygen, sulfur or phosphorus atom or a radical including a halogen, nitrogen, oxygen, sulfur or phosphorus atom, e.g. fluoro, chloro, cyano, nitro, hydroxyl, phosphate, thiol, etc. Thus the substituted hydrocarbyl moiety may possess, for example, a heteroatom (e.g. O, S, N, etc).

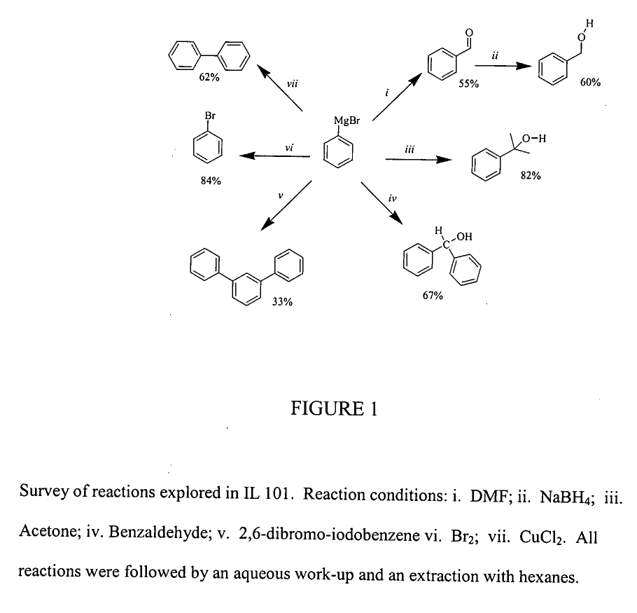

The term “PIL reaction media” as used herein refers to the combination of a PIL solvent and one or more reagents. As will be apparent from the detailed description below, PIL solvents may serve as a valuable carrier for various reactive and synthetically valuable reagents. For example, the reaction media may comprise a Grignard reagent dissolved in a PIL solvent. The reaction media may also optionally include other co-solvents, such as THF, hexanes or toluene. The reaction media can be combined with a reactant to perform a chemical reaction to produce one or more reaction products. As shown in FIG. 1, examples of reactants reactive with Grignard reagents include DMF, NaBH₄, benzaldehyde, dibromoiodobenzene, Br₂ and CuCl₂.

### Formation and Use of Reaction Media

The PIL solvents of the present invention may be formed from a broad range of phosphonium cations and a broad range of anions. As explained above, such solvents include phosphonium salts that have the general formula [PR₄]⁺[X]⁻ where R is independently a hydrocarbyl or substituted hydrocarbyl moiety and X is any anion. Suitable anions include, for example, halides, phosphinates, alkylphosphinates, alkylthiophosphinates, sulphonates, amides, tosylates, aluminates, borates, arsenates, cuprates, sulfates, nitrates, carboxylates, acetate, decanoate, citrate and tartrate. By way of further example, suitable PIL solvents may be selected from the group consisting of trihexyl(tetradecyl) phosphonium chloride, trihexyl(tetradecyl) phosphonium decanoate, tripentyl(tetradecyl) phosphonium chloride, trioctyl(tetradecyl) phosphonium chloride, trihexyl(tetradecyl) phosphonium bromide, trihexyl(tetradecyl) phosphonium bis (trifluoromethylsulfonyl)imide, trihexyl(tetradecyl) phosphonium dicyclohexylphosphinate, trihexyl(tetradecyl) phosphonium tetrafluoroborate, trihexyl(tetradecyl) phosphonium triflate, trihexyl(tetradecyl) phosphonium tris(trifluoromethylsulfonyl)imide, trihexyl(tetradecyl) phosphonium tris(trifluoromethylsulfonyl)methide, and triisobutyl(tetradecyl)(methyl) phosphonium tosylate.

One of the most readily available and affordable PILs is trihexyl(tetradecyl) phosphonium chloride which is available from Cytec Canada Inc (CYPHOS® IL 101). Whereas the trihexyl(tetradecyl) phosphonium cation is available with numerous other anions, some of which have favourable properties such as lower viscosity and donor solvent abilities, they are often somewhat more expensive since they are often prepared from trihexyl(tetradecyl) phosphonium chloride via ion exchange reactions. While commercially produced. PILs, specifically CYPHOS® IL 101 (trihexyl(tetradecyl) phosphonium chloride) are available in high purity, these ionic liquids typically contain traces of residual phosphines, HCl or other acidic species, and water. Due to the sensitivity of many basic reagents, such as organometallic or hydridic molecules, purification of PILs is desirable. In accordance with the invention, any excess HCl or other acidic species in the PILs is neutralized by aqueous sodium hydrogen carbonate. Care should be taken since there can be excessive foaming in this step. The ionic liquid layer is then washed vigorously with water and extracted using hexanes. For the organometallic reactions described below, it is important to remove all traces of water. The PILs can be dried by azeotropic distillation with toluene or benzene. Optionally, they can also be further dried at this stage with a small amount of solid potassium metal. It is noteworthy that the PILs do not react with elemental potassium (which in theory is the source of the simplest base, the electron).

Reaction media comprising PILs are suitable for a broad class of reactants and/or reaction types. For example, one or more of the following basic reagents may be dissolved in the PIL solvent to form a persistent and homogenous reaction media:

1. Grignard reagents

2. Hydrides commonly BH₃ and NaBH₄

3. Phenoxides

4. Alkoxides

5. Acetylides

6. Amides

7. Metallic reducing agents such as sodium or potassium

8. Non-metallic reducing agents, such as dithionite

9. Wittig reagents, such as Ph₃P═CH₂

10. Carbenes, such as N-heterocyclic carbenes

The reaction media may then be combined with one or more reactants to form the target product(s).

As will be appreciated by a person skilled in the art, the order in which the solvent, reagent and reactant are combined is sometimes not necessarily critical. For example, in some cases the reactant may first be combined with the PIL solvent and the reagent (such as a Grignard reagent) may then be added to the mixture to perform a chemical reaction. After the desired chemical reaction, further steps may be performed to isolate the desired reaction product and/or recycle the solvent for further use.

By way of further illustration, the desired reactions may be performed in several manners, including:
1. The basic reagent (e.g. a reagent from items 1-10 above) is mixed with the PIL solvent and the reactant is then added, either neat or in solution, or
2. The reactant is mixed with the PIL solvent and the reagent (in solution, or neat) is then added to the mixture.

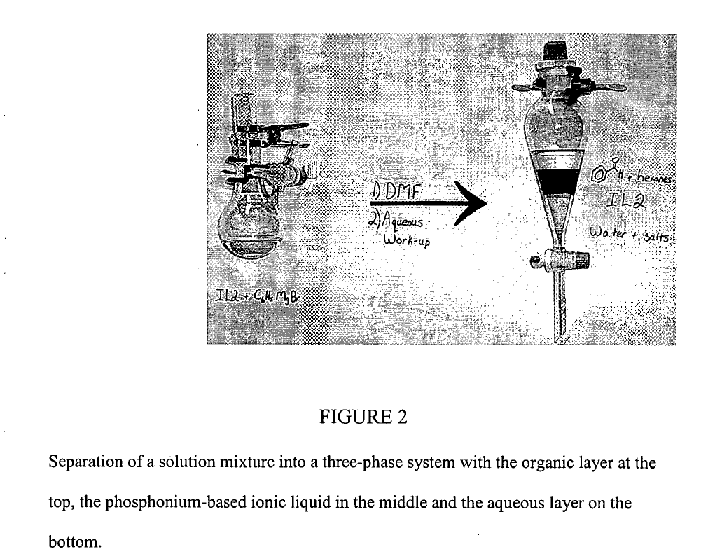

After the reaction, the product(s) can be isolated either by extraction or by distillation/sublimation. For example, the PIL can be reclaimed and recycled after reaction either by:
1. Addition of water followed by extraction of the product using an organic solvent. After several extraction and water washes, the PIL can be warmed to drive off volatiles, dried, and reused; or
2. The product can be distilled from the PIL, and the PIL washed with water and organic solvent, if necessary, to remove any salts/organics.
   As shown in FIG. 2, after the desired chemical reaction is performed, the addition of water and hexanes to the reaction mix results in the formation of a three-phase system, with the organic layer on the top, ionic liquid in the middle, and the aqueous layer on the bottom. As explained above, in some other cases the product can be distilled directly from the phosphonium-based ionic liquid.

### Comparison of PILs and IILs

PIL solvents and reaction media have different chemical characteristics than more conventional imidazolium-based ionic liquids (IILs). While IILs have been known to support many reactions that proceed well in what can be considered to be acidic reaction conditions^{16,17,34} the track record for IILs to support reactions involving strong bases is considerably less favourable.^{20,21} The most common problem encountered by IILs in basic conditions is deprotonation of the C—H site as shown in Scheme 1.

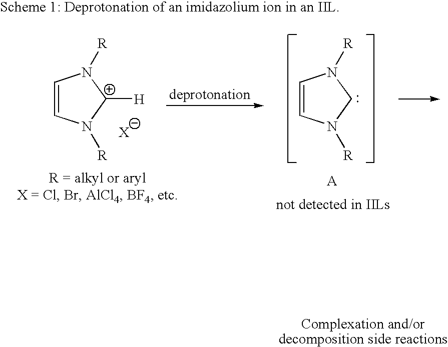

As shown in Scheme 1, carbenes (A) are neutral molecules possessing dicoordinated carbon atom with two non-bonding electrons. They are six electron species and accordingly very reactive.³⁵ N-heterocyclic carbenes (NHCs) are of particular interest due to their numerous applications in synthetic chemistry.^{19,36} NHCs are highly basic and are strong donor ligands with poor π-acceptor characteristics. This class of ligand has been extensively used in transition metal chemistry as shown in the structure below to stabilize low³⁷ and, more recently, high oxidation state metal complexes.³⁸ Access to these important species as a “free” (or uncomplexed) reagent in an IL would be particularly advantageous.

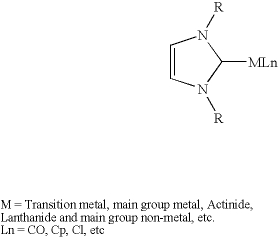

Organometallic chemistry in ILs is dominated by the formation of metal-carbene complexes and has heretofore focused primarily on IILs. For example, organometallic reagents¹⁴ have been used in ILs, and new metal carbonyl complexes have been incorporated into ILS.³⁹ Allylation reactions using tetraallylstannane, indium and tin as catalyst^{40,41} have also been reported. Synthesis and use of zinc reagents for organometallic reaction in ILs have also been carried out.^{42,43} However, the use of ILs as reaction media for free or uncomplexed carbenes has not been extensively investigated. NHCs and other bases such as phosphines dissolved in ILs could have numerous potential applications in catalysis including the cyclotrimerization of isocyanates,⁴⁴ generation of homoenolates,⁴⁵ organocatalytic living polymerization,46 ring-opening polymerization of cyclic esters⁴⁷ and carbon-carbon bond formation reactions.⁴⁸ Metal-carbene complexes are highly reactive in a wide variety of useful organic reaction types; however, their formation in ionic liquids nevertheless shows one of the major downfalls of IILs since the acidic C—H bond in the imidazolium ions is extremely reactive, both in acid-base chemistry as well as redox chemistry. In some catalytic reactions, this deprotonation reaction can be of great use and importance^{49,50,51} (i.e., it generates an active metal/NHC complex), but in other cases, such as in the Baylis-Hillman reaction (Scheme 2A), deprotonation reactions (Scheme 2B) results in a significant decrease in reaction yields.²⁰

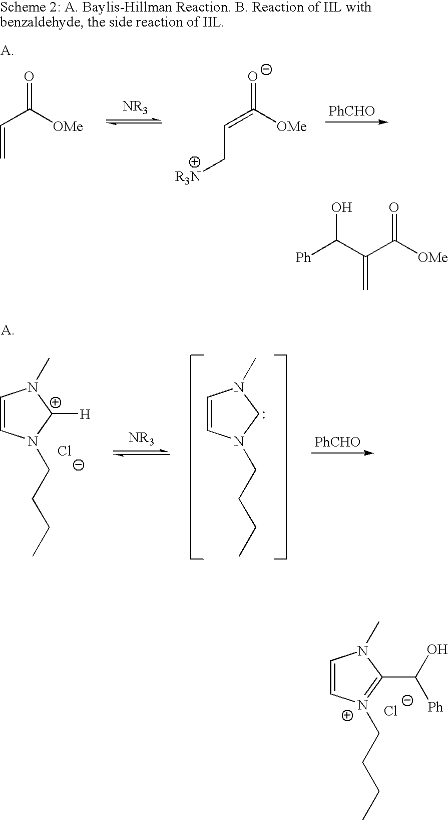

In this application the inventors demonstrate that PILs appear to be more robust than IILs and can be used as solvents for Grignard reactions⁵² and for dissolving other carbon centred ligands among others. Moreover, PILs can be used as solvents for dissolving NHCs and for a number of unexpected applications namely, generating NHCs, and for preparing metal complexes of the NHCs.

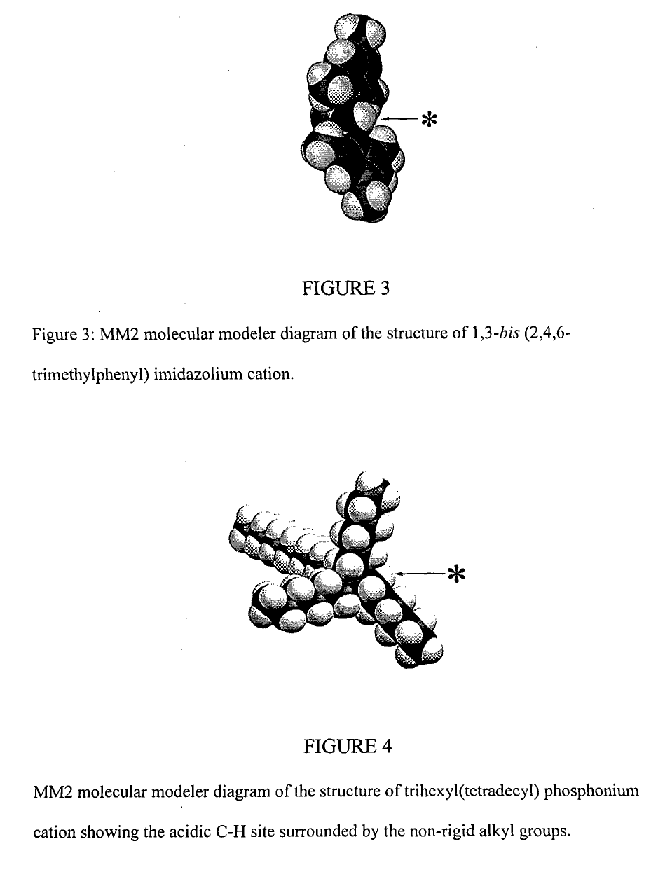

As described in the Examples below, there appears to be steric reasons why deprotonation reactions occur more in imidazolium-based ionic liquids than in phosphonium-based ionic liquids. The imidazolium ring is more rigid whereas the alkyl chains on the phosphonium ions are flexible and thus provide more protection to the reactive proton. As shown in the space filling diagrams of the relevant molecules, namely 1,3-bis(2,4,6-trimethylphenyl) imidazolium ion (FIG. 3) and trihexyl(tetradecyl) phosphonium ion (FIG. 4), it is very difficult to sterically shield the carbeneic site in the imidazolium ion, whereas in the trihexyl(tetradecyl) phosphonium ion there is considerable steric congestion and flexibility and hence access to the reactive C—H site is diminished. Electronic factors may also contribute to make the PILs more resistant to reduction than IILs.

The inertness of PILs (e.g. CYPHOS® IL 101) towards reaction with bases therefore appears to have primarily a kinetic basis. Although it would be reasonable to expect that deprotonation of a phosphonium ion to produce phosphorane and a salt would be thermodynamically favored, evidence of this reaction has not been observed. Contrast this with Wittig reagents, which are derived from materials analogous to PILs (CYPHOS® IL 101), but generally with significantly shorter alkyl groups.^{×} Access to the reactive protic site on CYPHOS® IL 101 is difficult and hence the Grignard reagents dissolve in the CYPHOS® IL 101 but fail to react with the phosphonium component. Further support for this kinetic argument is provided by noting that [Ph₃PCH₂CH₃]⁺[Br]⁻ is deprotonated to form a phosphorane by CYPHOS® IL 103/PhMgBr solutions or other bases such as potassium tert-butoxide as shown by ³¹P{¹H} NMR studies. These solutions exhibit a single signal at 15 ppm, consistent with the presence of Ph₃P═CH(CH₃),53 and also consistent with an original sample dissolved in the phosphonium ionic liquid.

### Persistence and Stability of Reagents in PILs

Perhaps the most readily available carbon-based nucleophiles are commercial solutions of Grignard reagents in tetrahydrofuran. As a representative example of this important class of reagent is phenylmagnesium bromide (PhMgBr) in PIL. As demonstrated in the Examples below, anhydrous samples of CYPHOS® IL 101 form clear solutions with low viscosity when mixed with commercially available 1M PhMgBr in tetrahydrofuran.^{↑} The solutions are air and moisture sensitive, but can be stored under an inert atmosphere. Most importantly, deprotonation of the PIL CYPHOS® IL 101 to produce a phosphorane has not been observed.

Addition of anhydrous bromine to fresh solutions of PIL CYPHOS® IL 101/Grignard reagent resulted in the exclusive formation of PhBr. Further, 5% of biphenyl was detected when the one-month-old PIL CYPHOS® IL 101/Grignard reagent solution was quenched with Br₂. For these aged solutions, the presence of benzene was not observed, again consistent with no deprotonation of the PIL CYPHOS® IL 101. However, complete removal of THF from the PIL CYPHOS® IL 101/Grignard solutions results in the formation of biphenyl and a variety of products that can be traced to the decomposition of the PIL CYPHOS® IL 101, including tetradecyl(dihexyl)phosphine and hexene. Electron transfer can explain this result from the Grignard reagent to the PILs CYPHOS® IL 101. For reactivity studies the best results were obtained when the ratio of THF:PIL CYPHOS® IL 101 was 1:3.

Ether free Grignard solutions in phosphonium-based ionic liquids were also synthesized using trihexyl(tetradecyl) phosphonium decanoate as detailed in the Examples below. To the phosphonium-based ionic liquid, a few drops of THF was added and the solution was cooled to −78° C. and to it Grignard reagents dissolved in THF was added and allowed to stir at room temperature for 15 minutes. THF was removed in vacuo to yield an ether free Grignard solution that was stable over a month.

### Reactivity of Grignard and Other Reagents in PILs

As detailed in the Examples below, a survey of chemical reactions was performed to determine the reactivity of Grignard reagents in PILs including addition to carbonyl compounds (i, ii, iii), benzyne reactions (iv), halogenation (v) and coupling reactions (vi) (FIG. 1).

After the reaction of the electrophile and the Grignard reagent at room temperature, addition of water and hexanes to the reaction mixture result in the formation of a three-phase system (FIG. 2), with the organic layer on the top, ionic liquid in the middle and the aqueous layer on the bottom. An added benefit for this system is the high heat capacity of PIL and therefore it is not necessary to cool the reaction solutions to the extremely low temperatures often needed for ethereal solutions. The products were isolated from the organic layer and analyzed by Gas-Chromatography Mass Spectrometry (GC-MS). In some cases, the low yields reported in FIG. 1 reflect the partitioning between the ionic liquid and the organic phase. Isolated yields can be markedly improved by successive extractions. In some cases, due to the high thermal stability of the PILs and the volatility of the products, distillation-could be used to remove the product from the reaction mixtures. In all cases, the PIL (e.g. CYPHOS® IL 101) can be washed with water and hexanes, dried, and re-used.

As explained above, some of the most basic neutral ligands are the carbenes with pKₐ values in the range of 22 to 24.^{54,24} They have been used extensively in transition metal-based catalysis and they have been shown to be key ligands in a number of very important synthetic procedures. Highly basic solutions containing NHCs dissolved in PILs can be prepared by mixing the carbene with the phosphonium-based ionic liquid, followed by addition of several drops of benzene, or toluene to reduce viscosity, if necessary. The addition of the co-solvent facilitates dissolution and after dissolution, the co-solvent can be removed under vacuum with no effect on the stability of the remaining solution. Other strong neutral bases, such as triphenylphosphine, have been examined and have been found to be similarly persistent in PILs as shown by spectroscopic studies.

### Generations and Reactions of NHCs in PILs

The inventors have shown that imidazolium ions could be converted to nucleophilic carbenes by their treatment with metallic potassium¹⁸ and have concurrently noted that PILs do not react with potassium metal under the conditions described. Thus, treatment of 1,3-bis(2,4,6-trimethyl)phenylimidazolium chloride suspended in PILs with potassium results in the formation of 1,3-bis(2,4,6-trimethyl)phenylimidazol-2-ylidene. It was also noted that when 1,3-bis(2,4,6-trimethyl-phenyl) imidazolium chloride in CYPHOS® IL 101 was treated with PhMgBr, the corresponding NHC was obtained further confirming that the reactive C—H site is more accessible in the IIL than in the PIL. This compound is unambiguously assigned by the observation of the ¹³C NMR for the carbeneic carbon≈216 ppm, as well as through reactivity studies (see below). The solutions are highly viscous and light brown in color. Likewise, these highly basic solutions are stable in excess of one month and are active for organic transformations, for example treatment of 1,3-bis(2,4,6-trimethyl)phenylimidazol-2-ylidene in PIL catalyses the condensation of benzaldehyde (benzoin condensation) with a yield of 40%.

The inventors have surveyed the chemistry of NHCs in PILs through an examination of some well-established NHC chemistry. The products were characterized exclusively in PIL using techniques such as NMR, IR and Mass spectroscopy (MS), GC-MS and elemental analysis. The NHC solutions prepared in CYPHOS® IL 101 behave as normal carbene solutions as shown in Scheme 3. Two representative examples from the p-block⁵⁶ and the d-block transition metals were chosen to illustrate the reactivity of NHCs in PIL. Treatment of the NHC with S₈ produces the thione as indicated by ¹³C NMR spectroscopy and mass spectrometry. Diagnostic peak of the thione in MS (CI) occurs at 336.3. These data are consistent to that previously reported for IMes=S.⁵⁷ NHCs coordinated to transition metal site have attracted interest in catalysis and we illustrate the reactivity of NHC in CYPHOS® IL 101 by reacting the solution with Cr(CO)₆. Displacement of one carbonyl occurs to afford IMesCr(CO)₅ as identified in IR studies.

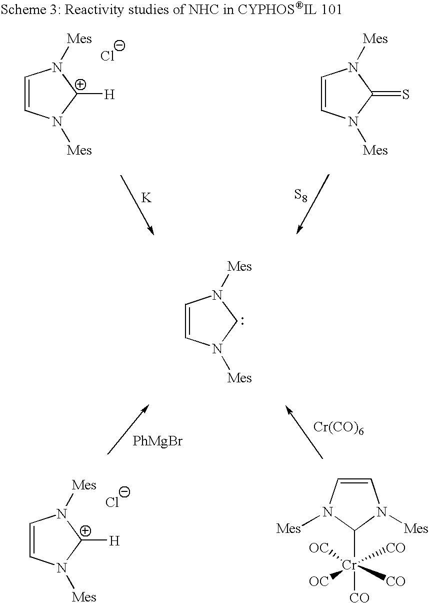

Generation of Highly Basic Phosphoranes (Wittig Reagents) and their use in Ionic Liquids

Synthetically, one of the most valuable classes of C-based nucleophiles are the phosphoranes, also known as Wittig reagents.³³ These molecules react readily with aldehydes and ketones to produce C═C double bonds, from which other valuable reactions proceed. Wittig reagents range from weakly basic, ‘stabilized ylides’ (pKa of the conjugate acid ca. 8-11) to highly basic derivatives (pKa of [Ph₃P—CH₃] ca. 22.5 in DMSO). Use of stabilized derivatives have been reported in IILs, but generation of the ylides and especially the highly basic ones, has not been reported. The ability of PILs to be inert with respect to reactions with many bases makes these attractive reagents to be prepared. A general reaction scheme for a Wittig reaction is shown in Scheme 4 below.

Generation of Wittig reagents is possible in PILs. For example, [Ph₃PCH₂CH₃]⁺[Br]⁻ is deprotonated to form a phosphorane by CYPHOS® IL 103/PhMgBr solutions or other bases such as potassium tert-butoxide as shown by ³¹P{¹H} NMR studies. The phosphorane obtained by deprotonation of [Ph₃PCH₂CH₃]⁺[Br]⁻ has a distinctive ³¹P{¹H} peak at 15 ppm consistent with the phosphorane dissolved in CYPHOS® IL 103. The resulting ylide is synthetically useful, and can be used in the Wittig reaction with aldehydes and ketones to generate an alkene as shown in the Examples section. The by-product of a Wittig reaction is triphenylphosphine oxide, and after reaction a white residue was isolated and characterized by mass spectrometry which exhibited a major peak at 278 amu.

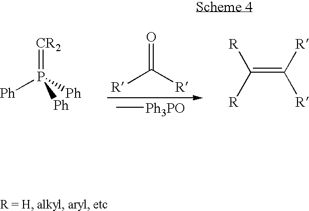

Catalytic C—C Bond Forming Reactions using Grignard Reagents in PILs

Up to now, we have primarily highlighted stoichiometric reactions involving Grignard reagents, although other reactions are possible. For example, catalytic C—C bond forming reactions using Grignard reagents are possible. Low valent transition metal complexes generated in situ can also act as a catalyst for C—C bond formation in PILs. Typically, such metal species react with IILs through oxidation addition reactions to the metal producing carbene complexes of the metal, and this can either be a positive or negative reaction for the metal sites. In PILs the low valent metal sites maintain their reactivity and behave as expected. For example, the Kumada-Corriu cross-coupling reaction proceeds well in PIL trihexyl(tetradecyl) phosphonium decanoate. The low valent nickel complex catalyst can be generated in situ by treatment of Ni(Cod)₂ (Cod=cyclooctadiene) and the free NHC 1,3-di(2,6-diisopropylphenyl)imidazol-2-ylidene and its reactivity is confirmed by the coupling of ether free solutions of PhMgBr in trihexyl(tetradecyl) phosphonium decanoate with the 4-halotoluene (halo=F, Cl, Br, I) as shown in Scheme 5 below.⁵⁸ Related amination reactions also proceed well and an example is provided in the Examples section.

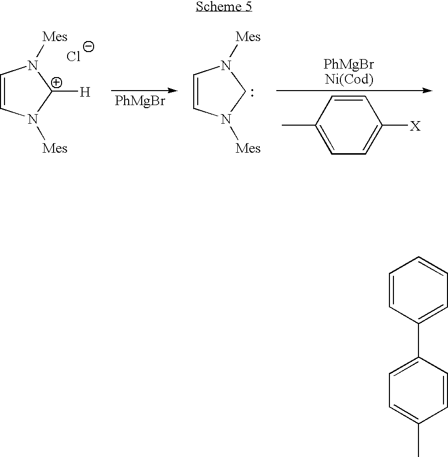

Finally, borane (BH₃) forms stable solutions with phosphonium ionic liquids. These are new materials that are highly efficient, odorless, non-volatile, nonflammable, and reusable reagents for borane transfer reactions. The hydride component of BH₃ does not react with the phosphonium cation and hence the PIL is a useful carrier of this versatile reagent. The inventors have demonstrated their utility in a number of carbonyl reduction reactions. These new materials should be potentially useful carriers of this highly reactive molecule for a wide variety of applications, especially in organic synthesis as well as, possibly, in fuel delivery systems, noting the potential importance of Borane as a hydrogen carrier. More experimental details are provided in the Examples section.

### EXAMPLES

The following examples will further illustrate the invention in greater detail although it will be appreciated that the invention is not limited to the specific examples.

### 1. General Procedure

Gas Chromatography Mass Spectrometry (GC-MS) was carried out on the extracts using Gas Chromatography Electron Ionisation detector G 1800A GCD system. Distillation was carried out using a standard Kulgelröhr apparatus. Reported yields were determined by gas chromatography using, where possible, reference materials, and the yields is determined by integration. In some cases, the yields reported are isolated yields. Standard techniques such as NMR infrared spectroscopy in combination with and elemental analysis were used to characterize reaction mixtures and products.

Purification of the phosphonium-based ionic liquids is important and a representative procedure is described here: Saturated sodium hydrogen carbonate (20 ml) was added to trihexyl(tetradecyl) phosphonium chloride or trihexyl(tetradecyl) phosphonium decanoate (120 mL) and stirred for 15 minutes. Vigorous foaming occurred. The solution was then washed with water (3×500 mL). The ionic liquid layer obtained was then extracted with hexanes (120 mL) and water (120 mL) in 3×40 mL aliquots. The ionic liquid was then dried by azeotropic distillation using toluene (20 mL), followed by exhaustive evacuation. ¹H NMR spectroscopy showed the absence of water in the ionic liquid and ³¹P NMR spectroscopy showed the presence of only one type of phosphorus site and no residual phosphines present. The dried ionic liquid can be stored in the presence of metallic potassium, which helps to maintain the anhydrous nature of the system.

2. Reaction of Phenylmagnesium Bromide with Dimethylformamide in Trihexyl(tetradecyl) Phosphonium Chloride

To dried ionic liquid trihexyl(tetradecyl) phosphonium chloride (15 mL), CYPHOS® IL 101, was added commercially available phenylmagnesium bromide solution in tetrahydrofuran (5.00 mL, 5.00 mmol). To it N,N′-dimethyl-formamide (0.37 g, 5.00 mmol) was added drop-wise and the solution was stirred under nitrogen for 3 hours. The reaction mixture was then quenched with saturated ammonium chloride followed by water. A single extraction step was performed as follows: Hexanes were added to form a three-phase system and the benzaldehyde was extracted in the hexanes layer. The hexanes layer was dried with anhydrous magnesium sulphate and filtered off. The extract was analyzed by GC-MS giving a 55% yield of benzaldehyde.

3. Reduction of Benzaldehyde with Sodium Borohydride in Trihexyl(tetradecyl) Phosphonium Chloride

To dried trihexyl(tetradecyl) phosphonium chloride (15 mL) (CYPHOS® IL 101), benzaldehyde (1.0 g, 9.41 mmol) was added. To this solution an excess of sodium borohydride (0.43 g, 11.46 mmol) was added and allowed to stir for 3 hours. The reaction mixture was then quenched with saturated ammonium chloride followed by water and hexanes to form a three-phase system. Hexanes extract was dried using anhydrous magnesium sulphate and filtered off. Both the hexanes layer and the ionic liquid layer were analyzed by GC-MS to give a 60% yield of benzyl alcohol.

4. Reaction of Phenylmagnesium Bromide with Acetone in Trihexyl(tetradecyl) Phosphonium Chloride

To dried ionic liquid trihexyl(tetradecyl) phosphonium chloride (15 mL), 1 M phenylmagnesium bromide solution in tetrahydrofuran (5.00 mL, 5.00 mmol) was added. To this stirred solution acetone (0.29 g, 5.00 mmol) was added dropwise and allowed to stir for 3 hours and quenched under nitrogen with saturated ammonium chloride followed by water. Hexanes were added to extract 2-phenyl-propan-2-ol and the hexanes extract after drying with anhydrous magnesium sulphate and ionic liquid layer were analyzed by GC-MS giving a total yield of 82%. Distillation under vacuum was also carried out giving a yield of 75%.

5. Reaction of 2,4,6-trimethylphenylmanesium Bromide with Benzaldehyde in Trihexyl(tetradecyl) Phosphonium Chloride

To dried ionic liquid trihexyl(tetradecyl) phosphonium chloride (15 mL), 1 M 2,4,6-trimethylphenylmagnesium bromide solution in tetrahydrofuran (2.80 mL, 2.80 mmol) was added and to it benzaldehyde (0.30 g, 2.80 mmol) was added dropwise and the mixture was stirred for 3 hours. The reaction mixture was then quenched with saturated ammonium chloride and water followed by hexanes. The ionic liquid layer was pumped to remove any trace of hexanes. The product was then removed from the ionic liquid using distillation giving a 50% yield of phenyl-(2,4,6-trimethyl-phenyl)-methanol.

### 6. Preparation of Stock Solutions of Ethereal Grignards in Trihexyl(tetradecyl) Phosphonium Chloride or Trihexyl(tetradecyl) Phosphonium Decanoate

Stock solutions of reaction media comprising Grignard reagents in phosphonium ionic liquids were prepared by mixing commercially available ethereal (i.e. in diethyl ether, tetrahydrofuran, etc.) solutions of Grignard reagents with phosphonium ionic liquids cooled at −78° C. Ethereal solutions of Grignard reagents dissolved in trihexyl(tetradecyl) phosphonium chloride or trihexyl(tetradecyl) phosphonium decanoate are air and moisture sensitive. These solutions show no significant sign of degradation after one month as shown by reactivity studies.

### 7. Generation of an Ether Free Solution Composed of a Grignard Reagent Dissolved in an Ionic Liquid

To trihexyl(tetradecyl)phosphonium decanoate (5 mL) with a few drops of THF (up to 1 mL), commercially available 1M phenylmagnesium bromide (5.0 mL) in THF was added at −78° C. The mixture was stirred and warmed to room temperature. Tetrahydrofuran was removed in vacuo leaving a viscous pale yellow or orange solution to which hexanes (2.0 mL) was added to reduce viscosity. Treatment of this solution with either bromine or N,N′-dimethylformamide followed by quenching with saturated aqueous ammonium chloride and addition of water followed by extraction with dichloromethane resulted in the formation of bromobenzene (98%) and benzaldehyde (99%), respectively, as determined by GC-MS studies.

### 8. Chemical Reaction Involving Potassium Metal in Phosphonium-based Ionic Liquids: Generation of an NHC in a PIL

1,3-bis(2,4,6-trimethylphenyl) imidazolium chloride (2.00 g, 5.87 mmol) and an excess of potassium metal (0.35 g, 8.75 mmol), previously washed with anhydrous THF, were added to trihexyl(tetradecyl) phosphonium chloride (10 mL). The reaction mixture was heated at 80° C. under nitrogen for 24 hours. Hexanes (10 ml) were added to the resulting suspension and the solution was filtered through Celite to remove undissolved materials. Evacuation to remove hexanes gave a brown viscous residue that was characterized as a solution of trihexyl(tetradecyl) phosphonium chloride and 1,3-bis(2,4,6-trimethylphenyl)-imidazol-2-ylidene. ¹H NMR (THF-d₈, 400 MHz): δ 2.08 (s, 2,6-CH₃, 12H), 2.31 (s, 4-CH₃, 6H), 6.96 (s, ArH, 4H), 7.14 (s, NCH, 2H); ¹³C NMR (THF-d₈, 101 MHz) 18.6 (s, 2,6-CH₃), 21.6 (s, 4-CH₃), 122.1 (s, NCC), 129.8 (s, Mes C-3,5), 136.2 (s, Mes C-2,6), 138.2 (s, Mes C-4), 139.9 (s, Mes C-1), 215.8 (s, NCN). These spectroscopic data are consistent with an original sample of 1,3-bis(2,4,6-trimethylphenyl)imidazol-2-ylidene dissolved in trihexyl(tetradecyl) phosphonium chloride.

### 9. Wittig Reactions: Formation of Methylstyrene in Phosphonium-based Ionic Liquids

To a cold (−78° C.) sample of trihexyl(tetradecyl) phosphonium decanoate (5 mL), 1 M phenylmagnesium bromide in THF (1.2 mL, 1.2 mmol) was added and allowed to slowly warm to room temperature. The THF was removed under vacuum, and to the resulting solution hexanes (approximately 2 mL) was added to reduce viscosity. Triphenylethylphosphonium bromide (0.4 g, 1.10 mmol) was then added to the solution. A color change from white to reddish orange was observed and the mixture was stirred under nitrogen for 1 hour. ³¹P{¹H} NMR showed a distinctive peak at 15.3 ppm for the deprotonation of triphenylethylphosphonium bromide to give the phosphorane. Benzaldehyde (0.11 g, 1.10 mmol) was then added to the mixture and an instant colour change from yellow to white was observed. The mixture was allowed to stir for 2 hours and then quenched with water. The product was extracted with dichloromethane which was dried using anhydrous magnesium sulphate to give methylstyrene (96%) analyzed by GC-MS. The presence of Ph₃PO was confirmed by mass spectrometry.

10. Formation of N-heterocyclic Carbenes in phosphonium-based Ionic Liquids

1,3-bis(2,4,6-trimethylphenyl)imidazolium chloride (0.25 g, 100% ¹³C labeled at C2) and a solution composed of ether free PhMgBr (2.00 mmol) dissolved in trihexyl(tetradecyl) phosphonium decanoate (5 mL) were mixed at room temperature. A small amount of toluene was added to reduce the viscosity and to facilitate stirring. NMR studies on the reaction mixtures show the presence of a major peak in the ¹³C NMR spectrum at 218 ppm, consistent with the formation of 1,3-bis(2,4,6-trimethylphenyl) imidazol-2-ylidene.

1,3-bis(2,4,6-trimethylphenyl) imidazolium chloride (2.00 g, 5.87 mmol) and an excess of potassium metal (0.35 g, 8.75 mmol), previously washed with anhydrous THF, were added to trihexyl(tetradecyl) phosphonium chloride (15 mL). The reaction mixture was heated at 80° C. under nitrogen for 24 hours. Hexanes (10 mL) were added to the resulting suspension and the solution was filtered through Celite. Evacuation to remove hexanes gave a reddish brown viscous material, and this residue was characterized as a solution of trihexyl(tetradecyl) phosphonium chloride and 1,3-bis(2,4,6-trimethylphenyl)imidazol-2-ylidene. ¹H NR (THF-d₈, 400 MHz): δ 2.08 (s, 2,6-CH₃, 12H), 2.31 (s, 4-CH₃, 6H), 6.96 (s, ArH, 4H), 7.14 (s, NCH, 2H); ¹³C NMR (THF-d₈, 101 MHz) 18.6 (s, 2,6-CH₃), 21.6 (s, 4-CH₃), 122.1 (s, NCC), 129.8 (s, Mes C-3,5), 136.2 (s, Mes C-2,6), 138.2 (s, Mes C-4), 139.9 (s, Mes C-1), 215.8 (s, NCN). These spectroscopic data are consistent with 1,3-bis(2,4,6-trimethylphenyl) imidazol-2-ylidene dissolved in trihexyl(tetradecyl) phosphonium chloride.

### 11. Use of Hydridic Reagents in Phosphonium-based Ionic Liquids

A stable compound having the general empirical formula trihexyl(tetradecyl) phosphonium chloride.BH₃ (1a.BH₃) or trihexyl(tetradecyl)-phosphonium decanoate.BH₃ (2a.BH₃) can be prepared by either passing gaseous B₂H₆ through samples of the pure ionic liquids or by addition of one equivalent of BH₃.THF solution followed by complete removal of the THF by exhaustive evacuation. Solutions of any ratio (e.g. 1-100%) of BH₃ to ionic liquid can be prepared. We have used these new ionic liquids (i.e. reaction media) for classic reductions involving borane, namely reduction of the carbonyl function. A series of reactions were performed by combining stoichiometric amounts (based on hydride) of carbonyl compounds with the new phosphonium-based ionic liquids at room temperature. Yields were determined by gas chromatography mass spectrometry analysis (GC-MS) of the extracts. The data are presented in chart 1 below.

CHART 1

| PIL · BH₃ | Reactant | Product | Yield (%) |
|---|---|---|---|
| 1a · BH₃ | Benzyldehyde | Benzyl alcohol | 94% |
| 2a · BH₃ | Benzyldehyde | Benzyl alcohol | 95% |
| 1a · BH₃ | Benzoyl chloride | Benzyl alcohol | 90% |
| 2a · BH₃ | Benzoyl chloride | Benzyl alcohol | 99% |
| 1a · BH₃ | Benzophenone | Benzhydrol | 60% |
| 2a · BH₃ | Benzophenone | Benzhydrol | 99% |
| 1a · BH₃ | Cinnamaldehyde | Cinnamyl alcohol | 75% |
| 2a · BH₃ | Cinnamaldehyde | Cinnamyl alcohol | 61% |
| 1a · 10% BH₃ | Benzaldehyde | Benzyl alcohol | 80% |
| 2a · 10% BH₃ | Benzaldehyde | Benzyl alcohol | 91% |

Spectroscopic data for the new borane containing materials: ¹H NMR(C₆D₆) of complex 1a.BH₃: δ 2.7-0.8 (various m); ³¹P NMR(C₆D₆) δ 33.5; ¹¹B NMR of 1a.BH₃ (C₆D₆) showed a very broad signal ca. 50 to −25 ppm with sharp features at 18.6 ppm, −12.0 ppm and a sharp quintet at −35.3 ppm assigned to BH₄⁻; IR (neat): 2956 (s), 2924 (s), 2855 (s), 2037 (m), 2212 (m), 2298 (s), 1465 (s), 1416 (s), 1378 (m), 1337 (s), 1261 (m), 1215 (m), 1166 (m), 1115 (s), 1071 (m), 814 (s), 721 (s) cm⁻¹; Anal. Calcd for C₃₂H₇₁BClP: C, 72.09; H, 13.42. Found: C, 72.39; H, 13.64. ¹H NMR(C₆D₆) of 2a.BH₃: an upfield shift of the ¹H NMR, δ 2.6-0.8 (various m); ³¹P NMR(C₆D₆) δ3.4; ¹¹B NMR of 2a.BH₃ (C₆D₆) showed a very broad peak ca. δ 50 to −25 ppm with sharp resonances at δ 18.1 ppm, 2.1 ppm and a very sharp quintet at −35.3 ppm assigned to BH₄⁻; IR (neat): 2956 (s), 2925 (s), 2855 (s), 2139 (m), 2224 (m), 2270 (s), 1661(s) (C═O stretch of 2a.BH₃ complex), 1579 (m) (C═O stretch of uncomplexed 2a), 1466 (s), 1416 (s), 1378 (m), 1337 (s), 1297 (m), 1150 (m), 1111 (m), 1075 (m), 720 (m), 669 (s).
12. Kumada-Corriu Cross-coupling Reaction with Ni Catalyst in Phosphonium-based Ionic Liquid

A stock solution of 1.0 M PhMgBr in THF (5 mL, 5 mmol) was added to cold IL 103 (5.0 mL) at −78° C. The reaction mixture warmed up to room temperature and the THF was removed in vacuo. To it toluene (0.5 mL) was added to reduce viscosity, followed by the addition of one equivalent (wrt PhMgBr) of 4-fluorotoluene, 4-chlorotoluene, 4-bromotoluene or 4-iodotoluene. To this solution, 0.05 mol percent of the complex bis[1,3-di(2′,6′-diisopropylphenyl)imidazolin-2-ylidene]nickel (O), prepared in situ by the reaction of nickel dicyclooctadiene and the free N-heterocyclic carbene in IL 103, was added. On addition of nickel dicyclooctadiene to N-heterocyclic carbene a color change from pale yellow to dark green was observed. The reaction mixture was stirred for 18 hours at room temperature under nitrogen and then quenched with a few drops of methanol and extraction was carried out using dichloromethane and water. The dichloromethane layer was then dried using anhydrous magnesium sulphate and then analysed by GC-MS. Yields are tabulated in Chart 2 below. In all cases a small amount (<2%) of biphenyl was observed.

CHART 2

| | | Yield of 4- | Yield of 4,4′-Dimethyl- |
|---|---|---|---|
| Reagent 1 | Reagent 2 | phenyltoluene | biphenyl |
| 4-fluorotoluene | PhMgBr | 42% | 0% |
| 4-chlorotoluene | PhMgBr | 88% | 0% |
| 4-bromotolene | PhMgBr | 73% | 25% |
| 4-iodotoluene | PhMgBr | 74% | 22% |

### 13. Synthesis of a Phenoxide in a Phosphonium-based Ionic Liquid and its Reactivity

Phenol (0.2 g, 2.13 mmol) was added to IL 103 (5.0 mL) followed by toluene (0.5 mL) to reduce viscosity. Potassium metal previously washed with THF (0.12 g, 3.19 mmol) was added to the reaction mixture and it was heated at 80° C. for 3 hours under nitrogen. A white precipitate formed. The excess potassium metal was removed and one equivalent of benzoyl chloride was added and the mixture was heated at 80° C. for 2 hours. No color change was observed. The reaction mixture was then quenched with water and extracted with dichloromethane. The extracts were dried with anhydrous magnesium sulphate and analyzed by GC-MS and the data was consistent with a 91% yield of phenyl benzoate.

### 14. Reaction of Magnesium Acetylides in Phosphonium-based Ionic Liquids

To trihexyl(tetradecyl) phosphonium decanoate (5 mL), commercially available 1M ethynylmagnesium bromide (5.0 mL) in THF was added at −78° C. The mixture was stirred and warmed to room temperature. Tetrahydrofuran was removed in vacuo leaving a viscous brown solution to which toluene (1 mL) was added to reduce viscosity. To this solution one equivalent of cyclohexanone was added and it was stirred for 16 hours under nitrogen. The reaction mixture was then quenched with water and then extracted with dichloromethane which was analysed by GC-MS after drying with anhydrous magnesium sulphate to give a 78% yield of 1-ethynyl-cyclohexanol.

To trihexyl(tetradecyl) phosphonium decanoate (5 mL) commercially available 1M phenylethynylmagnesium bromide (5.0 mL) in THF was added at −78° C. The mixture was stirred and warmed to room temperature. Tetrahydrofuran was removed in vacuo leaving a viscous brown solution to which toluene (1 mL) was added to reduce viscosity. To this solution one equivalent of benzaldehyde was added and it was allowed to stir for 16 hours under nitrogen. The reaction mixture was then quenched with water and then extracted with dichloromethane which was analysed by GC-MS after drying with anhydrous magnesium sulphate to give a 82% yield of 1,3-diphenyl-prop-2-yn-1-ol.

### 15. Reaction of Amides in Phosphonium-based Ionic Liquid

To trihexyl(tetradecyl) phosphonium decanoate (5 mL), commercially available 1M phenylmagnesium bromide (5.0 mL) in THF was added at −78° C. The mixture was stirred and warmed to room temperature. Tetrahydrofuran was removed in vacuo leaving a viscous orange solution to which toluene (1 mL) was added to reduce viscosity. Morpholine (0.44 g, 5.05 mmol) was added dropwise followed by 0.05 mol % of the complex bis[1,3-di(2′,6′-diisopropylphenyl)imidazolin-2-ylidene]nickel (O), prepared in situ by the reaction of nickel dicyclooctadiene and the free N-heterocyclic carbene in IL 103. A color change from orange to brown was observed. To the reaction mixture one equivalent (wrt morpholine) of 4-chlorotoluene was added and the solution was stirred for 16 hours under nitrogen at 85° C. The mixture was cooled to room temperature and the mixture quenched with the addition of a few drops of methanol and water and extracted using dichloromethane. The dichloromethane layer was then dried using anhydrous magnesium sulphate and analyzed by GC-MS giving 58% yield of 4-p-tolyl-morpholine.

To trihexyl(tetradecyl) phosphonium decanoate (5 mL), potassium tert-butoxide (0.85 g, 7.5 mmol) was added followed by toluene (1 mL) reduce viscosity. Morpholine (0.44 g, 5.05 mmol) was added dropwise followed addition of 0.05 mol % of the complex bis[1,3-di(2′,6′-diisopropylphenyl)imidazolin-2-ylidene]nickel (O), prepared in situ by the reaction of nickel dicyclooctadiene and the free N-heterocyclic carbene in IL 103. A color change from white to brown was observed. To the reaction mixture one equivalent (wrt morpholine) of 4-chlorotoluene was added and the solution was stirred for 16 hours under nitrogen at 85° C. The mixture was cooled to room temperature and the mixture quenched with the addition of a few drops of methanol and water and extracted using dichloromethane. The dichloromethane layer was then dried using anhydrous magnesium sulphate and analyzed by GC-MS giving 55% yield of 4-p-tolyl-morpholine.

### 16. Reaction of a Non-metallic Reducing Agent in Phosphonium-based Ionic Liquid

To trihexyl(tetradecyl) phosphonium decanoate (5 mL), iodine (ca. 0.2 g) was added. A dark red brown solution was obtained and to it sodium bisulphite was added with a few drops of water to increase solubitly of sodium bisulphate (excess). Decolorization from dark brown to pale yellow occurs without decomposition of the ionic liquid as confirmed by gas chromatography mass spectrometry.

### 17. Computational Studies

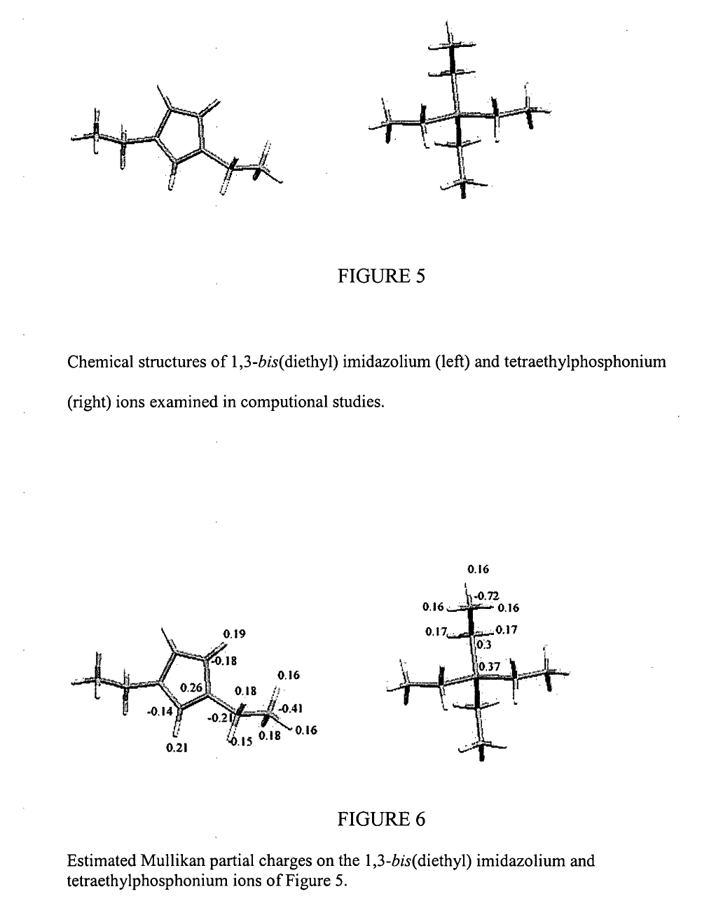

A study of symmetrically substituted imidazolium and phosphonium ions (FIG. 5) was performed to examine the partial charges in the alpha-protons in the relevant ions. All calculations were performed with the Gaussian 98 package of programs and the geometry was optimized at the UB3LYP/6-31G level and partial atom charges were calculated using the UB3LYP/6-311G*(2df,p) method.⁵⁹ The partial atom charges for the centers of interest and the results are shown in FIG. 6.

The structural parameters calculated for both the imidazolium⁶⁰ and phosphonium ions⁶¹ are comparable to those observed by X-ray crystallography. The estimated partial charges on the reactive C—H fragments, which are the potential points at which strong bases can interact with the cationic species, are of particular interest. As shown in FIG. 6, there are slightly greater charges on the reactive C—H sites in the imidazolium ion case, compared to the analogous sites in the phosphonium case.

Based solely on these results it is not clear why deprotonation reactions occur so readily for the imidazolium-based systems rather than the phosphonium ions. As discussed above, it is believed that the imidazolium ring is more rigid whereas the alkyl chains on the phosphonium ions are flexible and thus provide more protection to the reactive proton. As shown in the space filling diagrams on relevant molecules namely 1,3-bis(2,4,6-trimethylphenyl) imidazolium ion and trihexyl(tetradecyl) phosphonium ion (FIGS. 3 and 4), it is very difficult to sterically shield the carbeneic site in the imidazolium ion, whereas in the actual trihexyl(tetradecyl) phosphonium ion there is considerable steric congestion and flexibility and hence access to the reactive C—H site is diminished.

As will be apparent to those skilled in the art in the light of the foregoing disclosure, many alterations and modifications are possible in the practice of this invention without departing from the spirit and scope thereof. Accordingly, the scope of the invention is to be considered in accordance with the substance defined by the following claims:
(1) Williamson, P.T.; Anastas, C. T. Green Chemistry Designing Chemistry for the Environment, ACS Symposium Series 626, American Chemical Society: Washington, D.C. 1996.
(2) Rogers, R. D.; Seddon, K. R. Ionic Liquids: Industrial Applications to Green Chemistry, American Chemical Society: Washington, D.C., 2002.
(3) Zhao, D.; Wu, M.; Kou, Y.; Min, E. Catal. Today 2002, 74, 157.
(4) Ren, X. R.; Brenner, A.; Wu, J. X.; Ou, W. Proc. International Symposium on Molten Salts XIII, Electrochemical Society: Pennington 2002, 165.
(5) Freemantle, M. Chem. Eng. News 2003, 81, 9.
(6) Lancaster, M. Green Chemistry: An Introductory Text, Royal Society of Chemistry: Cambridge, UK, 2002.
(7) Tanaka, K.; Toda, F. Chem. Rev. 2000, 100, 1025.
(8) McHugh, M. A.; Krukonis, V. J. Supercritical Fluid Extraction, Butterworth-Heinemann: Newton, Mass., 1994.
(9) Jessop, P. G.; Leitner, W. Chemical Synthesis Using Supercritical Fluids, Wiley-VCH: Weinheim, 1999.
(10) Li, C-J.; Chan, T-K. Organic Reactions in Aqueous Media, John Wiley & Sons: New York, 1997.
(11) Wasserscheid, P. T.; Welton, T. Ionic Liquids in Synthesis, Wiley-VCH: Weinheim, 2003.
(12) de Wolf, E.; van Koten, G.; Deelman, B-J. Chem. Soc. Rev. 1999, 28, 37.
(13) Wasserscheid, P.; Keim, W. Angew. Chem. Int. Ed. Engl. 2000, 39, 3772.
(14) Dupont, J.; de Souza, R. F.; Suarez, P. A. Z. Chem. Rev. 2002, 102, 3667.
(15) Welton, T. Chem. Rev. 1999, 99, 2071.
(16) Qiao, K.; Yokoyama, C. Chem. Lett. 2004, 33, 472.
(17) Stark, A.; MacLean, B. L.; Singer, R. D. J. Chem. Soc., Dalton Trans. 1999, 63.
(18) Gorodetsky, B.; Ramnial, T.; Branda, N. R.; Clyburne, J. A. C. Chem. Commun. 2004, 1972.
(19) Arduengo, A. J. III. Acc. Chem. Res. 1999, 32, 913.
(20) Aggarwal, V. K.; Emme, I.; Mereu A. Chem. Commun. 2002, 1612.
(21) Jessop, P. G.; Leitner, W. Chemical Synthesis Using Supercritical Fluids, Wiley-VCH: Weinheim, 1999.
(22) Li, C.-J.; Chan, T.-K. Organic Reactions in Aqueous Media, John Wiley & Sons: New York, 1997.
(23) Dupont, J; Spencer, J. Angew. Chem. Int. Ed., 2004, 43, 5296.
(24) Kim, Y.-J.; Streitwieser, A. J. Am. Chem. Soc. 2002, 124, 5757. See also, (a) J. Fuller, and R. T. Carlin, J. Chem. Crystallogr., 1994, 24, 8, 489; (b) L. Xiao, and K. E. Johnson, J. Electrochem. Soc., 150, 6, E307.
(25) Kuhn, N; Bohnen, H.; Kreutzberg, J; Blaser, D.; Boese, R. J. Chem. Soc., Chem. Commun., 1993, 1136.
(26) Gale, R. J.; Osteryoung, R. A. J Electrochem. Soc. 1980, 2167.
(27) Raghavan, R.; Iwamoto, R. T. J Electroanal. Chem., 1979, 102, 85.
(28) Bradaric, C. J.; Downard, A.; Kennedy, C.; Robertson, A. J.; Zhou, Y. Green Chem., 2003, 5, 143.
(29) Badri, M.; Brunet, J.-J. Tetrahedron Lett. 1992, 33, 4435.
(30) Earlei M. J.; McCormac, P. B.; Seddon, K. R. Chem. Commun. 1998, 2245.
(31) Serjeant, E. P.; Dempsey, B. Ionisation Constants of Organic Acid in Aqueous Solution, Pergamon Press Ltd., 1979.
(32) Herman, G. R. Jr. Grignard Reagents New Developments, John Wiley & Sons, Inc.: New York, 2000.
(33) Smith, M. B.; March, J. Advanced Organic Chemistry: Reactions, Mechanism, and Structure, John Wiley & Sons, Inc.: New York, 2001.
(34) a) Imidazolium-based ionic liquids (IIL), specifically tetrachloroaluminate (III) salts, have been classified as acidic or basic depending on the relative amount of Cl⁻/AlCl₃ in the material-the anion [Al₂Cl₇]⁻ is a source of AlCl₃ which is a good Lewis acid for catalysis. We use the term “acidic” to emphasise the high reactivity of the C—H fragment in IILs; which, with strong bases, behave as protic acids. b) Holbrey, J. D.; Seddon, K. R. Clean Products and Processes 1 1999, 223. c) Earle, M. J.; Seddon, K. R. Pure Appl. Chem. 2000, 72, 1391.
(35) Bourissou, D.; Guerret, O.; Gabbaï, F. P.; Bertrand, G. Chem. Rev. 2000, 100, 39.
(36) Cowley, A. H. J. Organomet. Chem. 2001, 617-618, 105.
(37) Herrmann, W. A.; Öfele, K.; Elison, M.; Kühn, F. E.; Roesky, P. W.; J Organomet. Chem. 1994, 480, C7.
(38) Abernethy, C. D.; Codd, G. M.; Spicer, M. D.; Taylor, M. K. J. Am. Chem. Soc. 2003, 125, 1128.
(39) Schottenberger, H.; Wurst, K.;. Horvath, U. E. I; Cronje, S.; Lukasser, J.; Polin, J.; McKenzie, J. M.; Raubenheimer, H. G. Dalton. Trans. 2003, 4275.
(40) Gordon, C. M.; McCluskey, A. Chem. Commun. 1999, 1431.
(41) Gordon, C. M.; Ritchie, C. Green Chem. 2002, 4, 124.
(42) Kitazume, T.; Kasai, K. Green Chem. 2001, 3, 30.
(43) Law, M. C.; Wong, K-Y.; Chan, T. H. Green Chem. 2004, 6, 241.
(44) Duong, H. A.; Cross, M. J.; Louie, J. Org. Lett. 2004, 6, 4679.
(45) Sohn, S. S.; Rosen, E. L.; Bode, J. W. J. Am. Chem. Soc. 2004, 126, 14370.
(46) Nyce, G. W.; Glauser, T.; Connor, E. F.; Möck, A.; Waymouth R. M.; Hedrick, J. L. J. Am. Chem. Soc. 2003, 125, 3046.
(47) Connor, E. F.; Nyce, G. W.; Myers, M.; Möck, A.; Hedrick, J. L. J. Am. Chem. Soc. 2002, 124, 914.
(48) Methot, J. L.; Roush, W. R. Adv. Synth. Catal. 2004, 346, 1035.
(49) Xu, L.; Chen, W.; Xiao, J. Organometallics 2000, 19, 1123.
(50) Mathews, C. J.; Smith, P. J.; Welton, T.; White, A. J. P.; Williams, D. J. Organometallics 2001, 20, 3848.
(51) Hasan, M.; Kozhevnikov, I. V.; Rafiq, M.; Siddiqui, H.; Femoni, C.; Steiner, A.; Winterton, N. Inorg. Chem. 2001, 40, 795.
(52) Ramnial, T.; Ino, D. D.; Clybume, J. A. C. Chem. Commun. 2005, 325.
(53) Albright, T. A.; Gordon, M. D.; Freeman, W. J.; Schweizer, E. E. J. Amer. Chem. Soc. 1976, 98, 6249.
(54) Alder, R. W.; Allen, P. R.; Williams, S. J. J. Chem. Soc. Chem. Commun. 1995, 1267.
(55) For a general review of organocatalysis see Enders, D.; Kallfass, U. Angew. Chem. Int. Ed. 2002, 41, 1743.
(56) Carmalt, C. J.; Cowley, A. H. Adv. Inorg. Chem. 2000, 50, 1.
(57) Arduengo, A. J. III; Calabrese, J. C.; Cowley, A. H.; Rasika Dias, H. V.; Goerlich, J. R.; Marshall, W. J.; Riegel, B. Inorg. Chem. 1997, 36, 2151.
(58) Desmarets, C.; Schneider, R.; Fort, Y. J. Org. Chem. 2002, 67, 3029.
(59) Gaussian 98, Revision A.11.3, Frisch, M. J.; Trucks, G. W.; Schlegel, H. B.; Scuseria, G. B.; Robb, M. A.; Cheeseman, J. R.; Zakrzewski, V. G.; Montgomery, J. A. Jr.; Stratmann, R. E.; Burant, J. C.; Dapprich, S.; Millam, J. M.; Daniels, A. D.; Kudin, K. N.; Strain, M. C.; Farkas, O.; Tomasi, J.; Barone, V.; Cossi, M.; Cammi, R.; Mennucci, B.; Pomelli, C.; Adamo, C.; Clifford, S.; Ochterski, J.; Petersson, G. A.; Ayala, P. Y.; Cui, Q.; Morokuma, K.; Rega, N.; Salvador, P.; Dannenberg, J. J.; Malick, D. K.; Rabuck, A. D.; Raghavachari, K.; Foresman, J. B.; Cioslowski, J.; Ortiz, J. V.; Baboul, A. G.; Stefanov, B. B.; Liu, G.; Liashenko, A.; Piskorz, P.; Komaromi, I.; Gomperts, R.; Martin, R. L.; Fox, D. J.; Keith, T.; Al-Laham, M. A.; Peng, C. Y.; Nanayakkara, A.; Challacombe, M.;. Gill, P. M. W; Johnson, B.; Chen, W.; Wong, M. W.; Andres, J. L.; Gonzalez, C.; Head-Gordon, M.; Replogle, E. S.; Pople, J. A. Gaussian, Inc., Pittsburgh, Pa., 2002.
(60) Niehues, M.; Kehr, G.; Frohlich, R.; Erker, G. Z. Naturforsch, B: Chem. Sci. 2003, 58 b, 1005.
(61) Klapötke, T. M.; Schulz, A.; White, P. S.; Crawford, M. J. Heteroat. Chem. 1998, 9, 129.

1. A stable homogenous mixture comprising a recyclable phosphonium-based ionic liquid solvent having the general formula I. 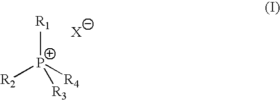
wherein R₁, R₂, R₃ and R₄ is independently a hydrocarbyl or substituted hydrocarbyl moiety and X is an anion; and a reagent dissolved in said solvent, wherein said reagent is selected from the group consisting of a strong base, a reducing agent and a nucleophile.

2. The mixture as defined in claim 1, wherein R₁, R₂, R₃ and R₄ is independently an alkyl group, a cycloalkyl group, an alkenyl group, an alkynyl group, or an aryl group.

3. The mixture as defined in claim 1, wherein said anion is selected from the group consisting of halides, phosphinates, alkylphosphinates, alkylthiophosphinates, sulphonates, amides, tosylates, aluminates, borates, arsenates, cuprates, sulfates, nitrates, carboxylates, acetate, decanoate, citrate and tartrate.

4. The mixture as defined in claim 1, wherein said solvent is selected from the group consisting of:
trihexyl(tetradecyl) phosphonium chloride,
trihexyl(tetradecyl) phosphonium decanoate,
tripentyl(tetradecyl) phosphonium chloride,
trioctyl(tetradecyl) phosphonium chloride,
trihexyl(tetradecyl) phosphonium bromide,
trihexyl(tetradecyl) phosphonium bis(trifluoromethylsulfonyl)imide,
trihexyl(tetradecyl) phosphonium dicyclohexylphosphinate,
trihexyl(tetradecyl) phosphonium tetrafluoroborate,
trihexyl(tetradecyl) phosphonium triflate,
trihexyl(tetradecyl) phosphonium tris(trifluoromethylsulfonyl)imide,
trihexyl(tetradecyl) phosphonium tris(trifluoromethylsulfonyl)methide, and
triisobutyl(tetradecyl)(methyl) phosphonium tosylate.

5. The mixture as defined in claim 1, wherein said solvent is trihexyl(tetradecyl) phosphonium chloride or trihexyl(tetradecyl) phosphonium decanoate

6. The mixture as defined in claim 1, wherein said solvent is anhydrous or nearly anhydrous.

7. The mixture as defined in claim 1, wherein said solvent is a purified solution and is substantially free of water.

8. The mixture as defined in claim 7, wherein said purified solution is substantially free of acidic species.

9. The mixture as defined in claim 1, wherein said mixture is substantially free of ethereal solvent.

10. The mixture as defined in claim 1, wherein said reagent is a Grignard reagent.

11. The mixture as defined in claim 1, wherein said reagent is a hydridic reagent.

12. The mixture as defined in claim 11, wherein said hydridic reagent is selected from the group consisting of BH₃, NaBH₄, a substituted borane and transitional metal or non-metal hydrides.

13. The mixture as defined in claim 1, wherein said reagent is selected from the group consisting of a nucleophilic carbene, a Wittig reagent, a phosphorane and a C-based nucleophile.

14. The mixture as defined in claim 1, wherein said reagent is a metal or a metal amalgam.

15. The mixture as defined in claim 1, further comprising a co-solvent selected from the group consisting of tetrahydrofuran, benzene, toluene, diethyl ether and a poly-ether.

16. Use of the mixture defined in claim 1, to perform chemical reactions.

17. Use as defined in claim 16, comprising adding a reactant to said mixture.

18. Use as defined in claim 17, wherein said reactant is an organic or organometallic compound.

19. Use as defined in claim 16, wherein said chemical reaction is selected from the group consisting of a reduction, an addition and a basic catalytic reaction.

20. Use as defined in claim 16, wherein said reactant is a metal and said mixture further comprises an imidazolium-based ionic liquid or an imidazolium ion.

21. A method of using a phosphonium-based ionic liquid for solution phase chemistry comprising:
(a) providing a phosphonium-based ionic liquid solvent having the general structure (I) as defined in claim 1 above;
(b) dissolving a reagent in said solvent to form a reagent solution, wherein said reagent is selected from the group consisting of a strong base, a reducing agent and a nucleophile; and
(c) using said reagent solution to perform a chemical reaction.

22. The method as defined in claim 21, comprising purifying said solvent prior to dissolving said reagent therein.

23. The method as defined in claim 22, where said purifying comprises removing any water present in said solvent.

24. The method as defined in claim 22, wherein said purifying comprises neutralizing any acidic species present in said solvent.

25. The method as defined in claim 21, further comprising recycling said solvent for reuse after said chemical reaction.

26. The method as defined in claim 21, wherein said chemical reaction is performed at room temperature.

27. The method as defined in claim 21, wherein said chemical reaction comprises reacting said reagent with a reactant introduced into said solvent.

28. The method as defined in claim 21, wherein said chemical reaction is selected from the group consisting of a reduction, an addition and a basic catalytic reaction.

29. The method as defined in claim 21, wherein said reagent is a Grignard reagent.

30. The method as defined in claim 21, wherein said reagent is a hydridic reagent.

31. The method as defined in claim 21, wherein said reagent is a metal or metal amalgam.

32. The method as defined in claim 21, wherein said reagent is selected from the group consisting of a nucleophilic carbine, a Wittig reagent, a phosphorane, a C-based nucleophile and a P- or S-ylide.

33. The method as defined in claim 27, wherein said reactant is an organic or organometallic compound.

34. The method as defined in claim 21, wherein said chemical reaction produces one or more organic or organometallic products, and wherein said method further comprises isolating said products from said solvent.

35. The method as defined in claim 34, wherein said products are isolated in a liquid phase layer separate from said solvent.

36. A product derived from the method defined in claim 21.

37. A method of synthesizing a nucleophilic carbene comprising reacting an imidazolium ion source with a metal in an organic liquid solvent.

38. The method as defined in claim 37, wherein said solvent is selected from the group consisting of a phosphonium ionic liquid and an ethereal solvent.

39. The method as defined in claim 37, wherein said imidazolium ion source is an imidazolium based ionic liquid.

40. The method as defined in claim 37, wherein said metal is metallic potassium.

41. A method of using a phosphonium-based ionic liquid for solution phase chemistry comprising:
(a) providing a phosphonium-based ionic liquid solvent having the general structure (I) as defined in claim 1 above;
(b) dissolving a Grignard reagent in said solvent to form a reagent solution; and
(c) using said reagent solution to perform a chemical reaction.
